(19) United States
(12) Patent Application Publication
(10) Pub. No.: US 2009/0003461 A1
(43) Pub. Date: Jan. 1, 2009

(54) ERROR CONCEALING METHOD AND APPARATUS ADAPTIVE TO CHARACTERISTICS OF BLOCKS ADJACENT TO LOST BLOCK

(75) Inventors: Se-an KWON, Seoul (KR); Min-jae Lee, Seoul (KR); Seung-Woo Shin, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/105,306

(22) Filed: Apr. 18, 2008

(30) Foreign Application Priority Data
Jun. 28, 2007 (KR) 2007-64612

(51) Int. Cl. H04N 7/26

(52) U.S. Cl. 375/240.27; 375/240.16; 375/E07.123

(57) ABSTRACT

An error concealment method and apparatus that are adaptive to characteristics of blocks adjacent to a lost block, the adaptive error concealment method including: determining one or more thresholds for selecting an error concealment method, from a plurality of error concealment methods, based on one or more of characteristics of blocks adjacent to a current block having an error; generating a temporal activity and a spatial activity of pixels adjacent to the current block; and selecting an error concealment method, from the plurality of error concealment methods, for the current block according to a result obtained by comparing the temporal activity, the one or more thresholds, and the spatial activity.

### CROSS-REFERENCE TO RELATED APPLICATION

This application claims the benefit of Korean Application No. 10-2007-0064612, filed on Jun. 28, 2007 in the Korean Intellectual Property Office, the disclosure of which is incorporated herein by reference.

### BACKGROUND OF THE INVENTION

1. Field of the Invention

Aspects of the present invention relate to an error concealment method and apparatus, and more particularly, to a method and apparatus for adaptively concealing an error of a block lost in a video codec apparatus based on blocks adjacent to the lost block.

2. Description of the Related Art

Video communication over a wireless network is sensitive to errors due to an instable channel environment that often causes packet loss. In order to avoid video quality degradation, encoders need an error reconstruction method and decoders need an error concealment method.

Conventional error concealment techniques use estimation or replacement of lost information caused by transmission errors. Specifically, the conventional error concealment techniques use correlations between adjacent blocks in the same frame as that of a lost block or a previous frame thereof in order to reconstruct the lost information.

Furthermore, the conventional error concealment techniques are classified into temporal error concealment and spatial error concealment. The temporal error concealment uses temporal redundancy in a sequence in an inter-coded frame. The spatial error concealment uses spatial redundancy in the same frame as that of the lost block (i.e., an intra-coded frame). The temporal error concealment estimates a lost motion vector in order to generate a temporally replaced block in which a motion of the lost block is compensated for. The spatial error concealment uses spatially adjacent blocks in order to estimate a lost pixel value generally by performing interpolation.

The temporal error concealment may result in visual errors due to motion between frames. Moreover, if motion vectors of adjacent blocks are damaged, the temporal error concealment may not exactly estimate damaged motion vectors, which may cause significant errors in reconstructed images. Similarly, if adjacent blocks are damaged in the same frame as that of a block to be reconstructed, spatial error concealment does not properly conceal an error of the block. Also, the spatial error concealment may cause a blurring phenomenon when a current block and blocks adjacent thereto are greatly different from each other in a pixel value, or have edges.

Therefore, although the conventional error concealment techniques are relatively advantageous in relation to a small motion between frames, a big motion between frames leads to concealment of an error of a wrong block, which causes deterioration in the capability of error concealment.

### SUMMARY OF THE INVENTION

Aspects of the present invention provide a method and apparatus for adaptively concealing an error of a block lost in a codec apparatus based on blocks adjacent to the lost block according to types and characteristics of the adjacent blocks.

Aspects of the present invention also provide a method of adaptively selecting an optimal error concealment method between a temporal error concealment method that uses a reference block of a reference frame and a spatial error concealment method that uses blocks adjacent to a current block.

According to an aspect of the present invention, there is provided an adaptive error concealment method to restore a current block of image data having an error, the method including: determining one or more thresholds for selecting an error concealment method, from a plurality of error concealment methods, based on one or more of characteristics of blocks adjacent to the current block having the error; generating a temporal activity and a spatial activity of pixels adjacent to the current block; and selecting an error concealment method, from the plurality of error concealment methods, for the current block according to a result obtained by comparing the temporal activity, and at least one among the one or more thresholds and the spatial activity.

The characteristics of blocks adjacent to the current block may be one or more of a motion of each block adjacent to the current block, a method of coding the blocks adjacent to the current block, and a number of blocks adjacent to the current block that have an error.

The determining of the one or more thresholds may include: establishing an initial value of a first threshold and an initial value of a second threshold, greater than the first threshold; estimating a mean value of motion vector values of one or more sub-blocks adjacent to the current block as a motion vector value of the current block; reducing the first threshold and the second threshold if the estimated motion vector value of the current block is greater than a predetermined value.

The method may further include: reducing the first threshold and the second threshold if a number of intra-coded blocks adjacent to the current block is greater than a predetermined number.

The method may further include: determining temporal error concealment if a number of blocks adjacent to the current block that are received without an error is smaller than a predetermined number,

The selecting of the error concealment method may include: when a first threshold and a second threshold having a greater value than that of the first threshold are used as the thresholds for selecting error concealment, if the temporal activity is smaller than the first threshold, selecting the temporal error concealment; if the temporal activity is greater than the second threshold, selecting the spatial error concealment; when the temporal activity is between the first threshold and the second threshold, if the temporal activity is smaller than the spatial activity, selecting the temporal error concealment, and if the temporal activity is not smaller than the spatial activity, selecting the spatial error concealment.

The spatial activity may be a mean square value of spatial difference values between values of the pixels adjacent to the current block and a mean pixel value of the values of the pixels adjacent to the current block.

The temporal activity may be a mean square value of different values between values of pixels adjacent to a block to be replaced from a reference frame and values of the pixels adjacent to the current block, using the mean value of motion vector values of sub-blocks adjacent to the current block.

The temporal error concealment may generate the block to be replaced from the reference frame by using the mean value of motion vector values of sub-blocks adjacent to the current block.

The spatial error concealment may use interpolation based on edges of one or more sub-blocks adjacent to the current block.

According to another aspect of the present invention, there is provided an adaptive error concealment apparatus to restore a current block of image data having an error, the apparatus including: a threshold determining unit determining one or more thresholds for selecting an error concealment method, from a plurality of error concealment methods, based on one or more characteristics of blocks adjacent to the current block that has the error; an activity generating unit generating a temporal activity and a spatial activity of pixels adjacent to the current block; and an error concealing unit selecting an error concealment method, from the plurality of error concealment methods, for the current block according to a result obtained by comparing the temporal activity, and at least one among the one or more thresholds and the spatial activity.

According to another aspect of the present invention, there is provided a computer readable recording medium having recorded thereon a computer program for executing the adaptive error concealment method.

According to another aspect of the present invention, there is provided an adaptive error concealment method to restore a current block of image data having an error, the method including: determining one or more thresholds for selecting an error concealment method, from a plurality of error concealment methods, based on one or more of characteristics of blocks adjacent to the current block having the error; generating a temporal activity of pixels adjacent to the current block; and selecting an error concealment method, from the plurality of error concealment methods, for the current block according to a result obtained by comparing the temporal activity and the one or more thresholds.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an adaptive error concealing apparatus according to an embodiment of the present invention;

FIG. 2 is a flowchart illustrating a method of selecting an adaptive error concealment method according to an embodiment of the present invention;

FIG. 3 is a diagram of variations of an adaptively selected range of error concealment according to adjustments of first and second thresholds;

FIG. 4 is a flowchart illustrating a method of adjusting first and second thresholds according to an embodiment of the present invention;

FIG. 5 is a diagram of a sub-block adjacent to a lost macro-block according to an embodiment of the present invention

FIG. 6 illustrates blocks and pixels for obtaining a temporal activity and a spatial activity according to an embodiment of the present invention;

FIG. 7A is a decoded image having a block in which an error occurred during video transmission;

FIG. 7B is an image reconstructed from the image shown in FIG. 7A using a conventional error concealment method;

FIG. 7C is an image reconstructed from the image shown in FIG. 7A according to an embodiment of the present invention; and

FIG. 8 is a flowchart illustrating an adaptive error concealment method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

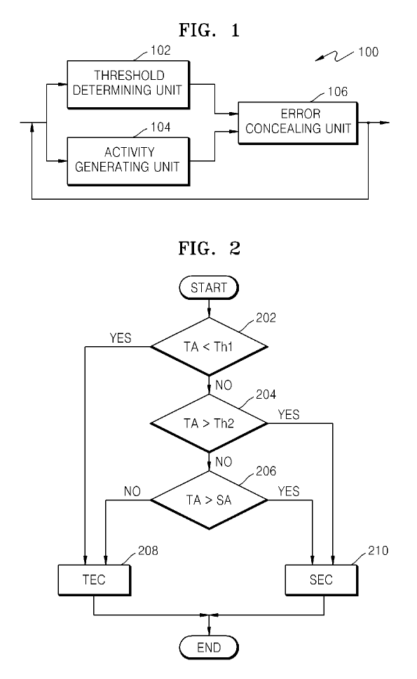

FIG. 1 is a block diagram of an adaptive error concealing apparatus 100 according to an embodiment of the present invention. Referring to FIG. 1, the adaptive error concealing apparatus 100 includes a threshold determining unit 102, an activity generating unit 104, and an error concealing unit 106.

Although not shown, the adaptive error concealing apparatus 100 may also include a predetermined error block detecting unit to detect a lost block caused by an error that occurred, for example, during video compression and/or data transmission in a communication environment.

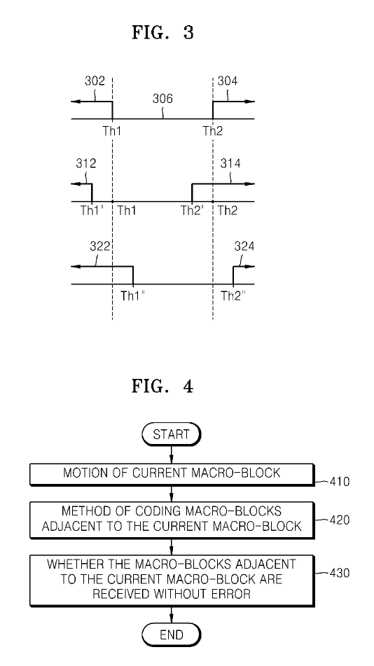

The threshold determining unit 102 determines a threshold value and sends the threshold value to the activity generating unit 104. The threshold value is a reference value for selecting an error concealment method applied to a lost current block due to an error of a current frame. The threshold value is determined according to a motion vector of the current block and/or characteristics of blocks adjacent to the current block (such as a coding method and occurrence of an error). A method of determining the threshold value will be described later with reference to FIGS. 3 through 5.

The activity generating unit 104 generates a temporal activity according to a temporal difference value of pixel values adjacent to the current block, generates a spatial activity according to a spatial difference value using a mean value of adjacent pixel values, and sends the temporal activity and the spatial activity to the error concealing unit 106.

The temporal activity is generated using a temporal difference value between the pixel values adjacent to the current block and pixel values adjacent to a replacement block of a reference frame. The replacement block is a block of the reference frame indicated by a motion vector of the current block that is estimated by using motion vectors of blocks adjacent to the current block. The spatial activity is generated using a spatial difference value between the mean value of pixel values adjacent to the current block and adjacent pixel values. The concept necessary to generate the temporal and spatial activities will be described later with reference to FIG. 6.

The error concealing unit 106 compares the threshold value determined by the threshold determining unit 102 and the temporal and spatial activities generated by the activity generating unit 104, and selectively conceals an error of the current block based on the comparison. A reconstructed block recurrently becomes a block adjacent to another block and is used as information on adjacent blocks in concealing an error of another block.

According to an aspect of the present invention, if block-based video compression is used in a communication environment, the block may be a macro-block, and an error of a block or a macro-block is concealed. Furthermore, since an error of each current block is concealed, a different concealment method can be applied to each current block lost in a current frame, as a threshold value, temporal activity, and spatial activity of each current block may be different from each other. Therefore, the error of each current block can be adaptively concealed according to characteristics of the current blocks and blocks adjacent to the current blocks. The operation of each component 102, 104, and 106 of the adaptive error concealing apparatus 100 will now be described in more detail with reference to FIGS. 2 through 6.

Adaptive error concealment that is performed by the error concealing unit 106 will now be described with reference to FIG. 2. Since video is compressed at several tens of frames per second, a current frame has redundant information in relation to a previous frame or a next frame. Therefore, it is possible to estimate a motion between the previous frame and the current frame, although the current frame has an error or a lost block. Specifically, information on the previous frame can be used to successfully reconstruct a block of the current frame. However, if there exists a big motion between the previous frame and the current frame or a scene therebetween is changed, it is difficult to accurately reconstruct the block of the current frame using the information on the previous frame. In this case, the block of the current frame is reconstructed from adjacent blocks of the current frame.

Meanwhile, if there is no edge between the current block and adjacent blocks in the current frame and no change in a pixel value thereof, pixel values of adjacent blocks of the current frame can be used to reconstruct the lost block. This is referred to as spatial error concealment that uses interpolation to reconstruct the lost block. However, if the lost bock is reconstructed based on spatial interpolation using adjacent blocks and the current block is a texture region, greatly changes in color, or has an edge with adjacent blocks, a blurring phenomenon may result.

Therefore, according to aspects of the present invention, the currently lost block can be more exactly reconstructed by adaptively determining an error concealment method according to characteristics of blocks adjacent to the current block.

FIG. 2 is a flowchart illustrating a method of selecting an adaptive error concealment method according to an embodiment of the present invention. According to an aspect of the present invention, a plurality of thresholds can be used. However, it is understood that according to other aspects, only one threshold may be used. In more detail, referring to FIG. 2, two thresholds (a first threshold Th1 and a second threshold Th2) are used. TA denotes a temporal activity, SA denotes a spatial activity, TEC denotes temporal error concealment, and SEC denotes spatial error concealment.

In operation 202, the temporal activity TA is compared to the first threshold Th1. If the temporal activity TA is less than the first threshold Th1, the temporal error concealment TEC is carried out (operation 208). In contrast, if the temporal activity TA is greater than the first threshold Th1, the process proceeds to operation 204.

The temporal activity TA is used to determine whether a big motion between a current frame and a reference frame exists. If it is determined that the big motion between the current frame and the reference frame does exist, the temporal error concealment TEC is not efficiently carried out since it is highly possible that an error will occur if a current block is generated using a block of the reference frame in this case.

Therefore, if the temporal activity TA is less than the first threshold Th1, it is determined that a small motion between the current block and the reference block exists since the current block and a reference block are similar to each other. Accordingly, the temporal error concealment TEC is carried out in operation 208.

On the other hand, if the temporal activity TA is greater than the first threshold Th1, it is determined that a big motion between the current block and the reference block exists. Accordingly, the temporal error concealment TEC is not carried out and another selection reference is further reviewed.

In operation 204, the temporal activity TA is compared to the second threshold Th2. If the temporal activity TA is greater than the second threshold Th2, the spatial error concealment SEC is carried out (operation 210). In contrast, if the temporal activity TA is less than the second threshold Th2, the process proceeds to operation 206.

In operation 206, the temporal activity TA and the spatial activity SA are compared to each other. If the spatial activity SA is greater than the temporal activity TA, it is determined that there is a high possibility that the current block spatially has an edge with the reference block or is a texture region, and thus the temporal error concealment TEC is carried out (operation 208). On the other hand, if the spatial activity SA is less than the temporal activity TA, it is determined that there is a high possibility that a big motion exists between the current block and the reference block, and thus the spatial error concealment SEC is carried out (operation 210).

The error concealment is selected according to characteristics of the current block and adjacent block. Thus, if a selection reference is adaptively set to the current block and/or the adjacent block, a reconstructed block can be much more similar to that of the original video. Furthermore, since the first threshold Th1 and the second threshold Th2 are applied to the adaptive error concealment according to aspects of the present invention, it is important to obtain the first threshold Th1 and the second threshold Th2 in order to more effectively carry out the adaptive error concealment.

It is understood that according to other aspects of the present invention, more or less threshold values may be used, resulting in more or less operations to determine the adaptive error concealment to be applied. Furthermore, it is understood that other comparisons may be used (i.e., comparisons other than checking just the temporal activity TA against the first threshold TH1 and the second threshold TH2). For example, the spatial activity SA may be compared to one or more threshold values to determine which adaptive error concealment is to be applied.

A process of adjusting the first threshold Th2 and the second threshold Th2 will now be described in more detail with reference to FIGS. 3 through 5. The process of adjusting the first threshold Th1 and the second threshold Th2 relate to the operation of the threshold determining unit 102 of the adaptive error concealing apparatus 100 illustrated in FIG. 1.

FIG. 3 is a diagram of variations of an adaptively selected range of error concealment according to adjustments of the first threshold Th1 and the second threshold Th2. Referring to FIG. 3, the first threshold Th1 and the second threshold Th2 have predetermined initial values, and the second threshold Th2 is greater than the first threshold Th1.

In a first range 302, the temporal activity TA is less than the first threshold Th1. In a second range 304, the temporal activity TA is greater than the second threshold Th2. In a third range 306, the temporal activity TA is between the first threshold Th1 and the second threshold Th2. Temporal error concealment and spatial error concealment are selected in the ranges 302 and 304, respectively, and one of them is selected in the third range 306 according to a comparison between the temporal activity TA and the spatial activity SA.

If the first threshold Th1 and the second threshold Th2 are reduced to Th1′ and Th2′, respectively, the first range 302 in which temporal error concealment is selected is reduced to a fourth range 312 and the second range 304 in which spatial error concealment is selected is increased to a fifth range 314. Therefore, a possibility that spatial error concealment is selected increases, whereas a possibility that temporal error concealment is selected decreases. That is, in order to increase the possibility that spatial error concealment is selected, the first threshold Th1 and the second threshold Th2 may be reduced.

On the other hand, if the first threshold Th1 and the second threshold Th2 are increased to Th1″ and Th2″, respectively, the first range 302 in which temporal error concealment is selected is increased to a sixth range 322 and the second range 304 in which spatial error concealment is selected is reduced to a seventh range 324. Therefore, the possibility that temporal error concealment is selected increases, whereas the possibility that spatial error concealment is selected decreases. That is, in order to increase the possibility that temporal error concealment is selected, the first threshold Th1 and the second threshold Th2 may be increased.

FIG. 4 is a flowchart illustrating a method of adjusting the first threshold Th1 and the second threshold Th2 according to an embodiment of the present invention. Referring to FIG. 4, the first threshold Th1 and the second threshold Th2 for selecting an error concealment method are adjusted on the basis of a motion of a current block, a coding type of blocks adjacent to the current block, and whether adjacent blocks are transmitted without an error.

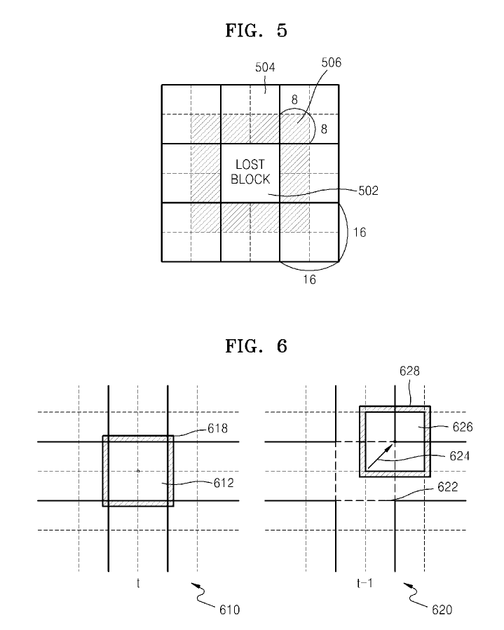

In operation 410, a motion of the currently lost block is used to adjust the first threshold Th1 and the second threshold Th2. According to an aspect of the present invention, a motion vector is used to detect the motion of the damaged current block. Since the current block is damaged due to the error, the motion vector of the current block is estimated from blocks adjacent to the current block. A method of estimating the motion vector of the current block from motion vectors of blocks adjacent to the current block will be described later with reference to FIG. 5. If the estimated motion vector of the currently lost block is greater than a predetermined number, a big motion of the currently lost block is detected. In this case, the first threshold Th1 and the second threshold Th2 are reduced in order to increase a possibility that spatial error concealment is selected.

In operation 420, the first threshold Th1 and the second threshold Th2 are adjusted according to a coding type of blocks adjacent to the currently lost block. According to an aspect of the present invention, the coding types of blocks adjacent to the current block having the error are used to adjust the first threshold Th1 and the second threshold Th2. When many (i.e., greater than a predetermined number) adjacent blocks are intra-coded using the current frame, since information on adjacent blocks of the current frame is useful, it is more effective to use spatial error concealment. Therefore, if there are many intra-coded adjacent blocks, spatial error concealment is selected, and the first threshold Th1 and the second threshold Th2 are reduced in order to decrease the possibility that temporal error concealment is selected.

In operation 430, the first threshold Th1 and the second threshold Th2 are adjusted according to whether blocks adjacent to the currently lost block are transmitted without an error. If a small number (i.e., less than a predetermined number) of blocks adjacent to the current block are received without an error, information on adjacent blocks is less trustworthy. Therefore, if a small number of adjacent bocks are received without error, since there is a high possibility that spatial error concealment that uses adjacent blocks will result in an inaccurate reconstruction of the current block, temporal error concealment is selected and the first threshold Th1 and the second threshold Th2 are increased in order to decrease the possibility that spatial error concealment is selected.

An error concealment method can be selected in all three operations 410, 420, and 430. However, aspects of the present invention are not limited thereto. For example, according to a communication environment or status, operation 410, a combination of operations 410 and 420, or a combination of operations 410 and 430 may be used to adjust the first threshold Th1 and the second threshold Th2.

FIG. 5 is a diagram of a sub-block 506 adjacent to a current block 502 having an error according to an embodiment of the present invention. In more detail, FIG. 5 is a diagram for explaining a process of estimating a motion vector value of a current block whose reconstruction is required from motion vector values of blocks adjacent to the current block.

Referring to FIG. 5, a set of blocks 504 is a set of eight 16×16 blocks that are adjacent to a lost current block 502. A set of sub-blocks 506 is a set of 8×8 sub-blocks that are adjacent to the lost current block 502 among sub-blocks of the set of blocks 504. It is understood that aspects of the present invention are not limited to these quantities (i.e., are not limited to eight 16×16 blocks and 8×8 blocks), and other quantities may be used.

A motion vector of each macro-block and each sub-block thereof are stored according to H.264 video compression and communication. In the present embodiment based on H.264 standard, in order to estimate a motion of the current block 502 in which an error occurs, a motion vector stored in each of the set of sub-blocks 506 is used to estimate the motion vector value of the current block 502. A mean value of motion vector values of sub-blocks adjacent to the current block 502 is estimated as the motion vector value of the current block 502. The estimated motion vector value is regarded as a motion of the current block 502 and is used as a threshold determination reference.

A method of generating a temporal activity TA and a spatial activity SA will now be described for a better understanding of the operation of the activity generating unit 104 of the adaptive error concealing apparatus 100.

The temporal activity TA is a mean value of temporal difference values between pixels adjacent to a current block. The temporal activity TA is obtained according to Equation 1:

TA=E[(x−x*)²] (1)

where x is a value of each adjacent pixel of the current block, x* is a value of each adjacent pixel of a block in a reference frame that is a replacement of the current block, and E[.] is a function used to obtain the mean value. The reference frame may be a previous or subsequent frame. The temporal activity TA can be used to predict a temporal similarity between the current block and the reference block of the reference frame. The smaller the temporal activity TA is, the greater the temporal similarity is, and vice versa.

The spatial activity SA is a mean value of spatial difference values between pixels adjacent to the current block. The spatial activity SA is obtained according to Equation 2:

SA=E[(x−u)²] (2)

where x is a value of the adjacent pixel of the current block, and u is a mean value of adjacent pixels of the current block. The reference frame may be a previous or subsequent frame. The spatial activity SA can be used to predict a spatial similarity between the current block and adjacent pixels thereof. The smaller the spatial activity SA is, the greater the spatial similarity is, and vice versa.

FIG. 6 illustrates blocks and pixels for obtaining the temporal activity TA and the spatial activity SA according to an embodiment of the present invention. Referring to FIG. 6, a frame 610 is a current frame at a time t. A frame 620 is a previous frame to the current frame 610 at a time t−1. A block 612 is a current block that has an error in the current frame 610. A plurality of pixels 618 are pixels adjacent to the current block 612. Therefore, x (of Equations 1 and 2) refers to the pixels 618. A block 622 is a block corresponding to the current block 612 in the previous frame 620. A motion vector 624 is an estimated motion vector value of the current block 610. A block 626 is a reference block estimated by the motion vector 624 of the current block 612. A plurality of pixels 628 are pixels adjacent to the reference block 626. Therefore, x* (of Equation 1) refers to a value of each of the pixels 628.

According to an aspect of the present invention, the temporal activity TA is a mean square value of temporal difference values of the pixels 618 (x in Equation 1) and the pixels 628 (x* in Equation 1). The spatial activity SA is a mean square value of spatial difference values between a mean value (u in Equation 2) of values of the pixels 618 and values of the pixels 618 (x in Equation 1).

Furthermore, the pixels 619 adjacent to the current block 612 or the pixels 629 adjacent to the reference block 626 may include pixels in a line surrounding the current block 612. However, aspects of the present invention are not limited thereto (for example, pixels in more than two lines can be applied). Also, when blocks are sequentially decoded, pixels to the right or to the left that are adjacent to the reference block that is previously decoded may be used. However, aspects of the present invention are not limited thereto (for example, some pixels adjacent to the current block can be applied).

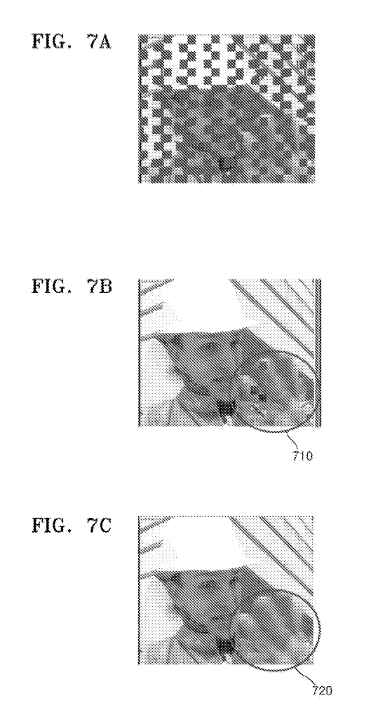

FIG. 7A is a decoded image having a block in which an error occurred during video transmission. FIG. 7B is an image reconstructed from the image shown in FIG. 7A using a conventional error concealment method. FIG. 7C is an image reconstructed from the image shown in FIG. 7A according to an embodiment of the present invention.

Referring to FIG. 7B, a conventional method does not consider a motion of a current block and blocks adjacent to the current block, a method of coding the blocks, and whether the blocks are transmitted without an error. As a result, an error spreads in the reconstructed image, which causes a block-based big error in a partial image 710 to occur. However, referring to FIG. 7C, when aspects of the present invention are applied, the block-based error is improved in a partial image 720 corresponding to the partial image 710 of FIG. 7B.

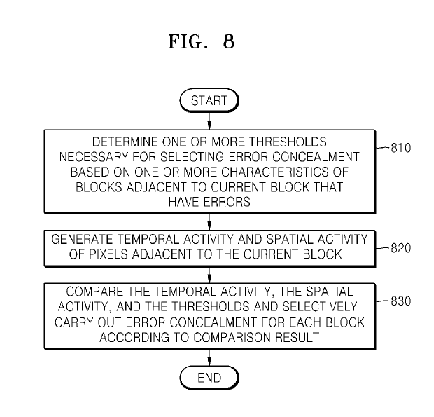

FIG. 8 is a flowchart illustrating an adaptive error concealment method according to an embodiment of the present invention. Referring to FIG. 8, in operation 810, one or more thresholds for selecting an error concealment method are determined based on one or more characteristics of blocks adjacent to a current block in which an error has occurred. According to aspects of the present invention, a motion of the current block having the error, a method of coding adjacent blocks, and/or whether adjacent blocks are received without an error are considered so as to determine the thresholds. However, it is understood that aspects of the present invention are not limited thereto. For example, more, less, or different characteristics may be considered.

In operation 820, a temporal activity and a spatial activity of pixels adjacent to the current block are generated.

In operation 830, the temporal activity, the spatial activity, and the thresholds are compared to one another, and error concealment is selectively carried out for each block according to the comparison result.

Aspects of the present invention can be written as computer programs and can be implemented in general-use digital computers that execute the programs using a computer-readable recording medium. Examples of the computer-readable recording medium include magnetic storage media (e.g., ROM, floppy disks, hard disks, etc.) and optical recording media (e.g., CD-ROMs, or DVDs).

According to aspects of the present invention, a block having an error in a decoded image is reconstructed by carrying out error concealment adaptive to types and characteristics of sub-blocks adjacent to the block having the error.

If a big motion of a lost block is estimated, thresholds are adjusted in order to increases a possibility that spatial error concealment is selected. If many blocks adjacent to the lost block are intra-coded, thresholds are also adjusted in order to increases a possibility that spatial error concealment is selected. If a large number of received adjacent blocks have errors, thresholds are adjusted in order to increase a possibility that temporal error concealment is selected in order to adaptively conceal an error of the lost block much closer to an original image. Accordingly, aspects of the present invention reduce the number of lost blocks, visually improve video quality, and increase a video peak signal-to-noise ratio (PSNR).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An adaptive error concealment method to restore a current block of image data having an error, the method comprising:
determining one or more thresholds for selecting an error concealment method, from a plurality of error concealment methods, based on one or more of characteristics of blocks adjacent to the current block having the error;
generating a temporal activity and a spatial activity of pixels adjacent to the current block; and
selecting an error concealment method, from the plurality of error concealment methods, for the current block according to a result obtained by comparing the temporal activity, and at least one among the one or more thresholds and the spatial activity.

2. The method as claimed in claim 1, wherein the characteristics of blocks adjacent to the current block are one or more of:
a motion of each block adjacent to the current block;
a method of coding the blocks adjacent to the current block; and
a number of blocks adjacent to the current block that have an error.

3. The method as claimed in claim 1, wherein the determining of the one or more thresholds comprises:
establishing an initial value of a first threshold and an initial value of a second threshold, greater than the first threshold;
estimating a mean value of motion vector values of one or more sub-blocks adjacent to the current block as a motion vector value of the current block; and
reducing the first threshold and the second threshold if the estimated motion vector value of the current block is greater than a predetermined value.

4. The method as claimed in claim 3, wherein the determining of the one or more thresholds further comprises:
reducing the first threshold and the second threshold if a number of intra-coded blocks adjacent to the current block is greater than a predetermined number.

5. The method as claimed in claim 3, wherein the determining of the one or more thresholds further comprises:
increasing the first threshold and the second threshold if a number of blocks adjacent to the current block that are received without an error is less than a predetermined number.

6. The method as claimed in claim 1, wherein the determining of the one or more thresholds comprises:
establishing an initial value of a first threshold and an initial value of a second threshold, greater than the first threshold; and
reducing the first threshold and the second threshold if a number of intra-coded blocks adjacent to the current block is greater than a predetermined number.

7. The method as claimed in claim 1, wherein the determining of the one or more thresholds comprises:
establishing an initial value of a first threshold and an initial value of a second threshold, greater than the first threshold; and
increasing the first threshold and the second threshold if a number of blocks adjacent to the current block that are received without an error is less than a predetermined number.

8. The method as claimed in claim 1, wherein:
the determining of the one or more thresholds comprises:
establishing a first threshold and a second threshold, greater than the first threshold; and
the selecting of the error concealment method comprises:
selecting a temporal error concealment if the temporal activity is less than the first threshold,
selecting a spatial error concealment if the temporal activity is greater than or equal to the first threshold and greater than the second threshold,
selecting the temporal error concealment if the temporal activity is between the first threshold and the second threshold and the temporal activity is less than the spatial activity, and
selecting the spatial error concealment if the temporal activity is between the first threshold and the second threshold and the temporal activity is not less than the spatial activity.

9. The method as claimed in claim 1, wherein the spatial activity is a mean square value of spatial difference values between values of the pixels adjacent to the current block and a mean value of the values of the pixels adjacent to the current block.

10. The method as claimed in claim 1, wherein the temporal activity is a mean square value of temporal difference values between values of pixels adjacent to a block to be replaced from a reference frame and values of the pixels adjacent to the current block, using a mean value of motion vector values of sub-blocks adjacent to the current block.

11. The method as claimed in claim 8, wherein the temporal error concealment generates the current block from a reference frame by using a mean value of motion vector values of sub-blocks adjacent to the current block.

12. The method as claimed in claim 8, wherein the spatial error concealment uses interpolation based on edges of one or more sub-blocks adjacent to the current block.

13. The method as claimed in claim 1, wherein the plurality of error concealment methods includes:
a temporal error concealment that generates the current block from a reference frame by using a mean value of motion vector values of sub-blocks adjacent to the current block; and
a spatial error concealment that uses interpolation based on edges of one or more sub-blocks adjacent to the current block.

14. An adaptive error concealment apparatus to restore a current block of image data having an error, the apparatus comprising:
a threshold determining unit to determine one or more thresholds for selecting an error concealment method, from a plurality of error concealment methods, based on one or more characteristics of blocks adjacent to the current block that has the error;
an activity generating unit to generate a temporal activity and a spatial activity of pixels adjacent to the current block; and
an error concealing unit to select an error concealment method, from the plurality of error concealment methods, for the current block according to a result obtained by comparing the temporal activity, and at least one among the one or more thresholds and the spatial activity.

15. The apparatus as claimed in claim 14, wherein the characteristics of blocks adjacent to the current block are one or more of:
a motion of each block adjacent to the current block;
a method of coding the blocks adjacent to the current block; and
a number of blocks adjacent to the current block that have an error.

16. The apparatus as claimed in claim 14, wherein the threshold determining unit:
establishes an initial value of a first threshold and an initial value of a second threshold, greater than the first threshold;
estimates a mean value of motion vector values of one or more sub-blocks adjacent to the current block as a motion vector value of the current block; and
reduces the first threshold and the second threshold if the estimated motion vector value of the current block is greater than a predetermined value.

17. The apparatus as claimed in claim 16, wherein the threshold determining unit reduces the first threshold and the second threshold if a number of intra-coded blocks adjacent to the current block is greater than a predetermined number.

18. The apparatus as claimed in claim 16, wherein the threshold determining unit increases the first threshold and the second threshold if a number of blocks adjacent to the current block that are received without an error is less than a predetermined number.

19. The apparatus as claimed in claim 14, wherein:
the threshold determining unit establishes a first threshold and a second threshold, greater than the first threshold; and
the error concealing unit:
selects a temporal error concealment if the temporal activity is less than the first threshold,
selects a spatial error concealment if the temporal activity is greater than or equal to the first threshold and greater than the second threshold,
selects the temporal error concealment if the temporal activity is between the first threshold and the second threshold and the temporal activity is less than the spatial activity, and
selects the spatial error concealment if the temporal activity is between the first threshold and the second threshold and the temporal activity is not less than the spatial activity.

20. The apparatus as claimed in claim 14, wherein the spatial activity is a mean square value of spatial differences between values of the pixels adjacent to the current block and a mean value of the values of the pixels adjacent to the current block.

21. The apparatus as claimed in claim 14, wherein the temporal activity is a mean square value of temporal difference values between values of pixels adjacent to a block to be replaced from a reference frame and values of the pixels adjacent to the current block, by using a mean value of motion vector values of sub-blocks adjacent to the current block.

22. The apparatus as claimed in claim 19, wherein the temporal error concealment generates the current block from a reference frame by using a mean value of motion vector values of sub-blocks adjacent to the current block.

23. The apparatus as claimed in claim 19, wherein the spatial error concealment uses interpolation based on edges of one or more sub-blocks adjacent to the current block.

24. A computer readable recording medium implemented by a computer and having recorded thereon a computer program for executing the method of claim 1.
